(19) United States
(12) Patent Application Publication
(10) Pub. No.: US 2019/0009912 A1
(43) Pub. Date: Jan. 10, 2019

(54) METHOD FOR AIR CONDITIONING OF AIRCRAFT, AND AIR CONDITIONING SYSTEM THEREFOR

(71) Applicant: TOKUYAMA CORPORATION, Shunan-shi, Yamaguchi (JP)

(72) Inventor: Shingo MATSUI, Shunan-shi (JP)

(73) Assignee: TOKUYAMA CORPORATION, Shunan-shi, Yamaguchi (JP)

(21) Appl. No.: 15/748,935

(22) PCT Filed: Aug. 29, 2016
(86) PCT No.: PCT/JP2016/075235

§ 371 Date: Jan. 30, 2018

(30) Foreign Application Priority Data
Aug. 31, 2015 (JP) 2015-170374

(51) Int. Cl. B64D 13/08; B64D 13/02

(52) U.S. Cl. CPC B64D 13/08; B64D 2013/0625; B64D 13/02

(57) ABSTRACT

A method for air conditioning of an aircraft includes the steps of: (A) obtaining a fresh air for ventilation; (B) exhausting an air from a cabin; (C) obtaining a purified air for recirculation, from a part of the air exhausted in the step (B); (D) obtaining an air for ventilation; (E) supplying the air for ventilation to the cabin; and (F) irradiating an ultraviolet ray emitted from a UV-LED to the fresh air for ventilation, an air for recirculation, the purified air for recirculation, and/or the air for ventilation.

### TECHNICAL FIELD

The present invention relates to methods and systems for air conditioning of an aircraft, that is, methods and systems for adjusting conditions of the air (pressure, temperature, humidity, the amount of ventilation, etc.) in a cabin of an aircraft to the desired conditions.

### BACKGROUND ART

It is necessary to ventilate passenger compartments (called a passenger cabin as well) of an aircraft so as to reserve a specified amount of air (250 l/min per one person). It is also necessary to carry out pressure adjustment (pressurization during flight) and temperature adjustment at the same time as ventilation because space outside an aircraft widely varies from the ground during parking (for example, at 1 atm at the ground temperature) to the lower stratosphere during flight (for example, at 0.2 atm at −70° C.). Therefore, fresh air for ventilation is taken in from the outside of an aircraft, adjusted to have proper pressure and temperature by an air conditioning system, and supplied to passenger compartments (passenger cabin).

The systems disclosed in Patent Literatures 1 to 7 are known as systems for air conditioning of an aircraft as described above.

For example, Patent Literature 1 discloses an air conditioning system for an aircraft, the system carrying out cooling or heating and ventilation of the air inside an aircraft, and at the same time supplying air for pressurization, the system extracting the air from an engine fan, compressing the extracted air by an electric compressor, cooling the compressed air in an evaporator of a vapor cycle cooling system using a refrigerant, or directly cooling the extracted air in the evaporator without compression by the electric compressor when the pressure of the air from the engine fan is sufficiently high, and thereafter feeding the conditioned air to a cabin and a cockpit. This system makes it possible to take in and compress the outside air, using the electric compressor, to cool the compressed air in the evaporator of the vapor cycle cooling system using a refrigerant, and thereafter to feed the conditioned air to the passenger cabin and the cockpit when an engine is stopped while the aircraft is parked on the ground.

Patent Literature 2 discloses an air conditioning system for an aircraft passenger compartment, the system including: an air supply circuit connecting at least one external air inlet to at least one air distribution outlet which can open in the compartment, and an auxiliary power unit mounted in the supply circuit and configured to compress an air stream in the supply circuit, the supply circuit including a heating first branch that connects the auxiliary power unit to the air distribution outlet, and in which a heating mechanism for heating the air stream is mounted, a cooling second branch that connects the auxiliary power unit to the air distribution outlet, and a switching mechanism configured to distribute the air stream between the heating first branch and the cooling second branch.

In these conventional systems for air conditioning of an aircraft, in most cases, after its pressure and temperature are adjusted, the air outside an aircraft (hereinafter also referred to as “fresh air for ventilation”) is mixed with recirculated air from a cabin such as passenger compartments (hereinafter also referred to as “cabin air for recirculation”), in a mixing chamber, to be supplied to the passenger compartments (see Patent Literatures 1 and 2). It is said that generally, the mixing ratio between the fresh air for ventilation and the cabin air for recirculation at this time is approximately 1:1.

The air in a cabin (hereinafter also referred to as “cabin air”) includes pollutants mainly derived from passengers, a crew, foods, drinks, insects and small animals that inevitably enter an aircraft, etc. Thus, it is general to remove or reduce these pollutants by an air-filtering process using a HEPA filter, an adsorbent filter, etc. when the cabin air is recirculated. “Cabin air for recirculation from which pollutants are removed or reduced” (hereinafter also referred to as “purified air for recirculation”) is mixed with the fresh air for ventilation, and supplied to a cabin as air for ventilation (see Patent Literature 6). As a result, it is said that the risk of in-flight transmission of infectious diseases is small.

### CITATION LIST

### Patent Literature

Patent Literature 1: JP 2001-10596 A

Patent Literature 2: JP 2014-516858 A

Patent Literature 3: JP 2008-534376 A

Patent Literature 4: JP 2009-537779 A

Patent Literature 5: JP 2006-131029 A

Patent Literature 6: JP 2009-526690 A

Patent Literature 7: JP 2000-103399 A

Patent Literature 8: JP H10-249128 A

Patent Literature 9: JP 2014-89898 A

Patent Literature 10: JP 2015-91582 A

Patent Literature 11: JP 2006-237563 A

Patent Literature 12: JP 2005-354067 A

Patent Literature 13: JP 2009-4688 A

### SUMMARY OF INVENTION

### Technical Problem

Virus itself cannot be removed completely even by a HEPA filter. In addition, cases of in-flight transmission of SARS, measles, etc. have been reported. Thus, an object of the present invention is to provide a method for air conditioning of an aircraft, which makes it possible to further reduce the risk of in-flight transmission of infectious diseases, and an air conditioning system therefor.

### Solution to Problem

The present invention solves the above problems in a conventional method and system for air conditioning, by ultraviolet sterilization of the cabin air to be recirculated.

Ultraviolet sterilization is a sterilization method using sterilizing effect of ultraviolet rays having 200 to 350 nm in wavelength. A popular ultraviolet light source is a low pressure mercury lamp (so-called germicidal lamp) that radiates light of 253.7 nm in wavelength (resonance line of mercury) (see Patent Literature 8). In recent years, examples of using ultraviolet light emitting diodes (hereinafter also referred to as UV-LED) have been proposed (see Patent Literature 9). However, any example where ultraviolet sterilization is introduced into systems for air conditioning of an aircraft has not been known.

A method for air conditioning of an aircraft according to a first aspect of the present invention comprises the steps of: (A) obtaining a fresh air for ventilation having adjusted pressure and temperature, the step (A) comprising: (1) bleeding a first fresh air having a first predetermined pressure and a first predetermined temperature; or (2) bleeding a second fresh air not having a second predetermined pressure and/or not having a second predetermined temperature, and adjusting pressure and temperature of the bled second flesh air to the second predetermined pressure and the second predetermined temperature; (B) exhausting an air from a cabin to an outside of the cabin; (C) obtaining a purified air for recirculation, the step (C) comprising: recovering part of the air exhausted in the step (B) as an air for recirculation; and removing or reducing a pollutant in the air for recirculation by means of a filter and/or an adsorbent; (D) mixing the fresh air for ventilation and the purified air for recirculation, to obtain an air for ventilation; (E) supplying the air for ventilation obtained in the step (D) to the cabin; and (F) irradiating an ultraviolet ray emitted from an ultraviolet light emitting diode to the fresh air for ventilation, the air for recirculation, the purified air for recirculation, or the air for ventilation before being supplied to the cabin, or combination thereof.

In the above described method for air conditioning of an aircraft of the present invention, the following embodiments can be preferably employed according to the additional effect to be obtained.

That is, in order to stably irradiate the ultraviolet ray, preferably, the step (A) comprises adjusting temperature of the second fresh air by means of a cooling turbine and/or a heat exchanger for cooling; and the step (F) comprises controlling temperature of the ultraviolet light emitting diode by means of: (1) a cooling fluid used in the heat exchanger for cooling; (2) an air cooled by means of the cooling turbine; or (3) the first fresh air bled in the step (A).

In order to further improve the effect of preventing infectious diseases, preferably, the cabin is divided into a plurality of zones; and the step

(B), the step (F) wherein the ultraviolet ray is irradiated to the air for recirculation, and the step (E) are carried out per each of the plurality of zones; or the step (B), the step (C), the step (F) wherein the ultraviolet ray is irradiated to the purified air for recirculation, and the step (E) are carried out per each of the plurality of zones.

For efficient sterilization, preferably, the step (F) is carried out under a higher air pressure than an air pressure in the cabin.

A system for air conditioning of an aircraft according to a second aspect of the present invention comprises: a ventilation air supply port supplying an air for ventilation into a cabin; a cabin air exhaust port exhausting an air from the cabin; an air bleeding port bleeding a fresh air, the fresh air not having a predetermined pressure and/or not having a predetermined temperature; a recirculation flow path comprising: an air pump incorporated in the recirculation flow path; and a filter apparatus incorporated in the recirculation flow path, the recirculation flow path purifying part of the air exhausted from the cabin air exhaust port by means of the filter apparatus, to prepare a purified air for recirculation; a bled air conditioning flow path comprising an air conditioning apparatus incorporated in the bled air conditioning flow path, the air conditioning apparatus comprising: a compressor; a cooling turbine; or a heat exchanger for cooling; or combination thereof, the bled air conditioning flow path adjusting pressure and temperature of the fresh air bled from the air bleeding port, to prepare a fresh air for ventilation; a mixing chamber comprising: a first inlet of the purified air for recirculation, the first inlet being connected with the recirculation flow path; a second inlet of the fresh air for ventilation, the second inlet being connected with the bled air conditioning flow path; and an outlet of the air for ventilation, the outlet being connected with the ventilation air supply port, the purified air for recirculation and the fresh air for ventilation being mixed in the mixing chamber, to give the air for ventilation; and an ultraviolet ray irradiator comprising an ultraviolet light emitting diode, the ultraviolet ray irradiator irradiating an ultraviolet ray emitted from the ultraviolet light emitting diode to an air flowing in the recirculation flow path.

In the above described system for air conditioning of an aircraft of the present invention, the following embodiments can be preferably employed according to the additional effect to be obtained.

That is, in order to stably irradiate the ultraviolet ray, preferably, the system for air conditioning of an aircraft further comprises: an ultraviolet light emitting diode cooler comprising: a heat sink or a radiator, radiating heat from the ultraviolet light emitting diode; and an ultraviolet light emitting diode cooling fluid flow path, wherein an ultraviolet light emitting diode cooling fluid flows in the ultraviolet light emitting diode cooling fluid flow path; the ultraviolet light emitting diode cooling fluid flow path being connected with a flow path of a cooling fluid used in the heat exchanger for cooling, or being connected with the bled air conditioning flow path; the ultraviolet light emitting diode cooling fluid comprising part of the cooling fluid used in the heat exchanger for cooling or part of the fresh air for ventilation; and the ultraviolet light emitting diode cooler making the ultraviolet light emitting diode cooling fluid directly or indirectly contact with the heat sink or the radiator, to cool the ultraviolet light emitting diode.

In order to efficiently irradiate the ultraviolet ray, preferably, the recirculation flow path comprises: a compressor as the air pump; a release valve or a turbine, arranged on a downstream side of the compressor; and a pressure space formed between the compressor and the release valve or the turbine; and the ultraviolet ray emitted from the ultraviolet light emitting diode being irradiated to an air flowing in the pressure space. In the system for air conditioning of an aircraft according to such an embodiment, in view of easy maintenance and relaxation of restrictions on placement of the light emitting diode, more preferably, the ultraviolet ray irradiator comprises: a light source arranged outside the pressure space, the light source comprising the ultraviolet light emitting diode; and an optical member for ultraviolet ray emission, arranged in the pressure space; the ultraviolet ray emitted from the ultraviolet light emitting diode going out from the optical member, in a manner such that the ultraviolet ray is irradiated to the air flowing in the pressure space.

A third aspect of the present invention is an aircraft comprising: the system for air conditioning of the aircraft according to the second aspect of the present invention.

### Advantageous Effects of Invention

The method for air conditioning of an aircraft and the system for air conditioning of an aircraft of the present invention can further reduce the risk of in-flight transmission of infectious diseases because the air for ventilation is subjected to ultraviolet sterilization. Further, this method and system have advantages of low power consumption, which can lead to low fuel consumption for generating electricity, and moreover no necessity for mercury because an ultraviolet light emitting diode (hereinafter may be abbreviated to

“UV-LED”) is used for ultraviolet sterilization.

When the above described preferred embodiments are employed, the above described additional effect can be obtained respectively.

### BRIEF DESCRIPTION OF DRAWINGS

FIG. 1 is an explanatory schematic view of a system for air conditioning of an aircraft according to one embodiment.

FIG. 2 is an explanatory schematic view of a system for air conditioning of an aircraft according to another embodiment.

FIGS. 3A and 3B are explanatory schematic views of one example of a sterilization chamber and an ultraviolet light source which can be used in the system for air conditioning of an aircraft of the present invention; FIG. 3A is a plan view of an ultraviolet sterilization chamber 43a, and FIG. 3B is a cross-sectional view taken along the line X-X in FIG. 3A.

FIGS. 4A and 4B schematically show the structure of the ultraviolet light source in FIGS. 3A and 3B; FIG. 4A is a plan view of an ultraviolet light source 45a, and FIG. 4B is a cross-sectional view taken along the line X-X in FIG. 4A.

FIGS. 5A and 5B are explanatory schematic views of another example of a sterilization chamber that can be used in the system for air conditioning of an aircraft of the present invention; FIG. 5A is a cross-sectional view showing a cross-section of an ultraviolet sterilization chamber 43b, parallel to a longitudinal direction of a pipe 80, and FIG. 5B is a cross-sectional view taken along the line X-X in FIG. 5A.

FIGS. 6A and 6B are explanatory schematic views of yet another example of a sterilization chamber and an ultraviolet light source which can be used in the system for air conditioning of an aircraft of the present invention; FIG. 6A is a plan view of a sterilization chamber 43c, and FIG. 6B is a cross-sectional view taken along the line X-X in FIG. 6A.

FIGS. 7A to 7C are explanatory schematic views of still another example of an ultraviolet light source that can be used in the system for air conditioning of an aircraft of the present invention; FIG. 7A is a plan view of an ultraviolet light source 100, FIG. 7B is a cross-sectional view taken along the line A-A in FIG. 7A, and FIG. 7C is longitudinal and lateral cross-sectional views of a rod-like module light source 110.

### DESCRIPTION OF EMBODIMENTS

A method for air conditioning of an aircraft according to the first aspect of the present invention comprises the steps of: (A) obtaining a fresh air for ventilation having adjusted pressure and temperature, the step (A) comprising: (1) bleeding a first fresh air having a first predetermined pressure and a first predetermined temperature; or (2) bleeding a second fresh air not having a second predetermined pressure and/or not having a second predetermined temperature, and adjusting pressure and temperature of the bled second flesh air to the second predetermined pressure and the second predetermined temperature; (B) exhausting an air from a cabin to an outside of the cabin; (C) obtaining a purified air for recirculation, the step (C) comprising: recovering part of the air exhausted in the step (B) as an air for recirculation; and removing or reducing a pollutant in the air for recirculation by means of a filter and/or an adsorbent; (D) mixing the fresh air for ventilation and the purified air for recirculation, to obtain an air for ventilation; (E) supplying the air for ventilation obtained in the step (D) to the cabin; and (F) irradiating an ultraviolet ray emitted from an ultraviolet light emitting diode to the fresh air for ventilation, the air for recirculation, the purified air for recirculation, or the air for ventilation before being supplied to the cabin, or combination thereof.

Methods for air conditioning of an aircraft comprising the above described steps (A), (B), (C), (D), and (E) have been conventionally known as described in Patent Literatures 1 to 7. There is no change from conventional methods in these steps even in the method of the present invention.

For example, bleeding means taking the air outside the aircraft (that is, fresh air) into the aircraft via an air bleeding port. The following bleeding methods are known: I. a method including taking the air into a parked aircraft from an air conditioning system that uses a ground air source such as a mobile air conditioning car for aircrafts, and a ground air conditioner (see Patent Literature 4: JP 2009-537779 A); and II. a method including taking the atmosphere outside an in-flight or parked aircraft via an engine compressor, a compressor of an APU (Auxiliary Power Unit), an engine fan, or the like of the aircraft. In the above method I., generally, the air that was adjusted in advance to having proper pressure and temperature according to the pressure and temperature of the air for circulation to be prepared in a mixing chamber is prepared in a ground air source (such as a mobile air conditioning car for aircrafts, and a ground air conditioner), and the prepared air is bled. In the method II., generally, an air of high temperature and high pressure is taken in when the air is bled via a compressor of an engine or an APU; and pressure of a taken air is raised enough for pressurization, using an electric compressor, when the air is taken in via an engine fan, etc.

The above particulars are also applied to the step (A) in the method of the present invention. The bled air that has been adjusted to having predetermined pressure and temperature in the above method I. corresponds to “first fresh air”, and the bled air in the above method II. corresponds to “second fresh air”. “First fresh air” becomes “fresh air for ventilation” as it is, to be introduced into a mixing chamber. “Second fresh air” is introduced into the mixing chamber after its pressure and temperature are adjusted to predetermined pressure and predetermined temperature, to become “fresh air for ventilation”. At this time, normally, “fresh air for ventilation” is adjusted so as to basically have pressure equal to that of the air for ventilation, that is, pressure equal to or higher than (usually, equal to or a little higher than) that in the cabin, which is pressurized if necessary, and have temperature lower than that of the air for ventilation.

The pressure and temperature of “second fresh air” are adjusted when the second fresh air is passing through a bled air conditioning flow path. Here, the bled air conditioning flow path is a flow path from the air bleeding port to an inlet of the fresh air for ventilation of the mixing chamber. The flow path include an air conditioning apparatus that has a compressor, a cooling turbine, or a heat exchanger for cooling, or combination thereof. The pressure and temperature of the second fresh air are adjusted here, to become the fresh air for ventilation. “First fresh air” is directly introduced into the mixing chamber without passing through the bled air conditioning flow path because the first fresh air itself becomes the fresh air for ventilation. Usually, “first fresh air” is used while the aircraft is parked, and “second fresh air” is used while the aircraft is moving. Thus, both of the airs are not used simultaneously. When the fresh air for ventilation is introduced into the mixing chamber, introducing lines of the fresh air for ventilation into the mixing chamber are switched by operation of valves, depending on whether the aircraft is parked or whether the aircraft is moving.

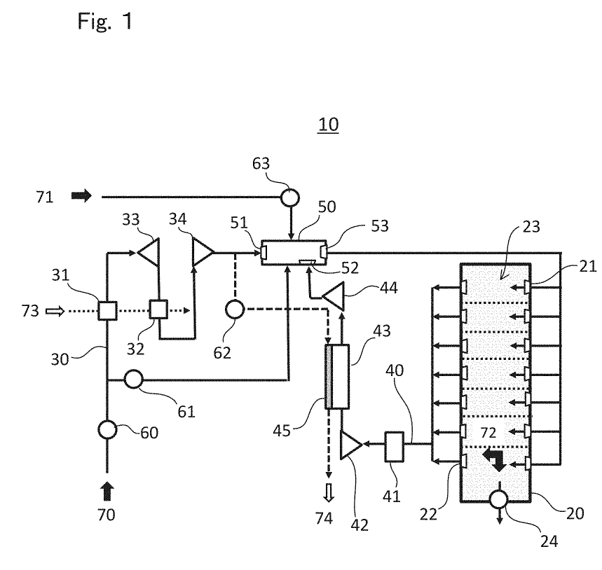

Generally, the pressure and temperature of “second fresh air” are adjusted by means of an ACS (Air Cycle System) using a heat exchanger and a turbine compressor. In this system, the pressure of “second fresh air” constituted by an air of high temperature and high pressure which is bled from a compressor of an engine and/or an APU via the air bleeding port is adjusted by a pressure regulator as needed. After cooled by a precooler (for example at 200° C. or lower), the second fresh air is made become a cold air having the desired pressure and temperature, by the ACS. When “second fresh air” constituted by an air of low temperature and low pressure is bled from an engine fan etc., after being pressurized by an electric compressor to be an air of high temperature, the second fresh air may be made become a cold air having the desired pressure and temperature, by the ACS, or by a cooling system (vapor cycle cooling system) by means of a heat pump function using latent heat of evaporation of a refrigerant such as a freon (see FIG. 1 of Patent Literature 1).

In the ACS, pressure and temperature are adjusted basically as follows using a machine comprising a compressor and a cooling turbine rotating together with the compressor, which is called an air cycle machine (ACM): that is, after cooled in the heat exchanger using a ram air (air of low temperature which is taken in by ram pressure caused by the velocity of the in-flight aircraft), the bled second fresh air (usually an air of high temperature and high pressure) is subjected to adiabatic compression by means of the compressor of the air cycle machine. After that, the second fresh air is cooled again in the heat exchanger using the ram air, and thereafter the second fresh air is subjected to adiabatic expansion by means of the cooling turbine, to be adjusted to have proper pressure and temperature. At this time, expansion energy of the air in the cooling turbine is recovered as shaft power and is utilized. When cooled beyond necessity, the air after adiabatic expansion is mixed with part of an air (second fresh air) that is divided and is taken out before entering the compressor of the ACM in a pipe or the mixing chamber, or is heated by heat exchange with an air of high temperature, to be adjusted to have proper temperature. Further modifications and improvements have been made to the above method of using the ACS, concerning removal of moisture, etc. according to sizes and characteristics of airframes. As described above, the cooling method using the ACM can be applied to cooling of the air that is taken in from the engine fan, etc., and pressurized using the electric compressor. For example, a hybrid air conditioning system using both an air bled from a compressor of an engine and/or an APU and an air bled from an engine fan is also known.

In the step (A) of the present invention, methods using systems that are used in conventional methods for air conditioning of an aircraft as described above can be employed without any restrictions. Examples of temperature and pressure adjustment systems that can be preferably employed in the present invention include a 2 wheel bootstrap system (including low-pressure water separation and high-pressure water separation, which are differentiated by a method of separating water. Either one may be employed.), a 3 wheel bootstrap system, a 4 wheel bootstrap system, a hybrid air conditioning system using a motorized air cycle machine (MACM), an advanced air conditioning system employing a no-bleed system (a system directly compressing the air from the outside of an aircraft by means of an electric motor using electric power supplied from an engine, instead of bleeding an air from an engine) and using a vapor cycle cooling system, and modified systems thereof.

The steps (B) to (E) will be described based on supply of the air for ventilation obtained in the step (D) into the cabin, and a flow thereafter. First, the air for ventilation prepared in the step (D) is usually guided to the center ceiling via riser ducts, thereafter fed to each zone of the aircraft via distribution ducts, and flows into the cabin from ventilation air supply ports provided near the ceiling [step (E)]. After circulating in the cabin, the air for ventilation flowing into the cabin goes out of the cabin via an air exhaust port provided for (usually both sides of) the floor of each zone [step (B)], flows into underfloor ducts, and is partially exhausted to the outside of the aircraft by means of pressure regulating valves, and the rest thereof is recirculated as the air for recirculation. The recirculated air is purified by passing through a filter and/or an adsorbent layer [step (C)].

“Cabin” is a general term for a cockpit or a flight deck, and a passenger cabin or passenger compartments, which are closed so as not to be directly exposed to the outside air. “Outside of a cabin” means a space in the aircraft, except the cockpit and the passenger cabin, and space outside the aircraft. Therefore, the spaces of the ceiling and under the floor of the passenger cabin, and the spaces in the ducts are the outside of the cabin.

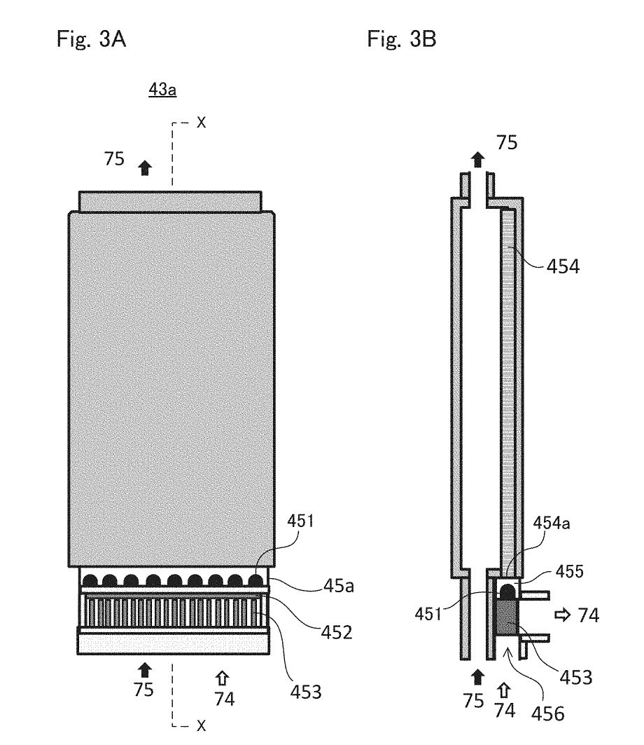

In the flow of the air for ventilation described above, the air exhausted in the step (B) (including pollutants) for taking in fresh air is partially exhausted to the outside of the aircraft. The air can be exhausted to the outside of the aircraft by using, for example, devices shown in FIGS. 1 and 3 of Patent Literature 5 (JP2006-131029A). The air in the cabin may be exhausted to the outside of the aircraft by using a dedicated exhaust port.

Recirculating means returning the cabin air exhausted to the outside of the cabin via a recirculation flow path, to the inside of the cabin again as the air for recirculation (more specifically, purified air for recirculation). The recirculation flow path is a flow path from the air exhaust ports to an inlet of the purified air for recirculation of the mixing chamber, including an air pump and a filter apparatus that are incorporated therein, and purifying part of the air exhausted from the cabin air exhaust ports by means of the filter apparatus, to prepare the purified air for recirculation. A fan or a compressor is usually used as the air pump. The filter apparatus is an apparatus to remove or reduce pollutants by means of various filters. The following are used as the filters: a prefilter for removing or reducing dusts and fibers, a HEPA filter for removing or reducing fine particles, bacteria, etc., an adsorption filter for removing or reducing odor, VOC, etc., a solid-amine filter for adsorbing carbon dioxide, and so on. A sub-circulation flow path as shown in FIG. 1 of Patent Literature 6 (JP 2009-526690 A) for partially exhausting nitrogen to the outside thereof to improve the oxygen concentration by passing through a nitrogen generator using polyimide based hollow fiber membrane, etc. may be connected to (may branch from and join with) the recirculation flow path. A cooling means using a vapor cycle cooling system as shown in FIG. 1 of Patent Literature 7 (JP 2000-103399 A) may be provided for the recirculation flow path.

In the present invention, preferably, a compressor is used as the air pump, and a release valve or a turbine is arranged on the downstream side of the compressor to form a pressure space, in order to efficiently carry out ultraviolet ray irradiation. At this time, preferably, the filter apparatus is arranged on the upstream side of the compressor.

The fresh air for ventilation obtained in the step (A), and the purified air for recirculation obtained in the step (C) pass through ducts or pipes, and are respectively introduced into the mixing chamber from the inlet of the fresh air for ventilation and the inlet of the purified air for recirculation of the mixing chamber, and mixed, to become the air for ventilation whose pressure and temperature are adjusted, so that the pressure and temperature in the cabin can be adjusted to be within the predetermined range [step (D)]. The pressure and temperature at this time can be controlled by controlling various control valves such as a temperature control valve, a pressure regulating valve, and a check valve, and various devices such as an electric compressor, based on information on temperature, pressure, flow rate, etc. detected by various sensors, as described in Patent Literature 7.

The method of the present invention further includes the step (F) in addition to the above described steps (A) to (E) of a conventional method for air conditioning of an aircraft. In the step (F), an ultraviolet ray emitted from an ultraviolet ray irradiator having an ultraviolet light emitting diode is irradiated to the fresh air for ventilation, the air for recirculation, the purified air for recirculation, or the air for ventilation before being supplied to the cabin, or combination thereof.

The above described ultraviolet light emitting diode (UV-LED) is preferably a deep ultraviolet light emitting diode (hereinafter may be referred to as “DUV-LED”) that emits a ultraviolet ray whose main peak is in the wavelength range from no less than 200 nm and less than 350 nm, especially no less than 200 nm and less than 300 nm. Irradiating an ultraviolet ray of such a wavelength makes it possible to sterilize the air to be irradiated. For example, it is known that if 6.6 mWsec/cm²(=mJ/cm²) of an ultraviolet ray of 254 nm in wavelength is irradiated, 99.9% of an influenza virus is inactivated.

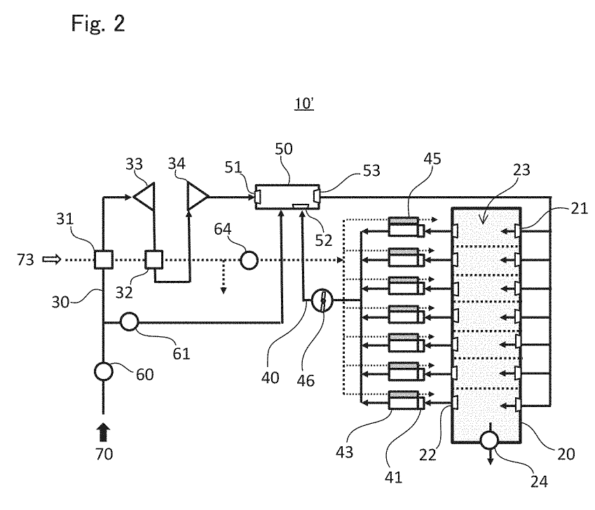

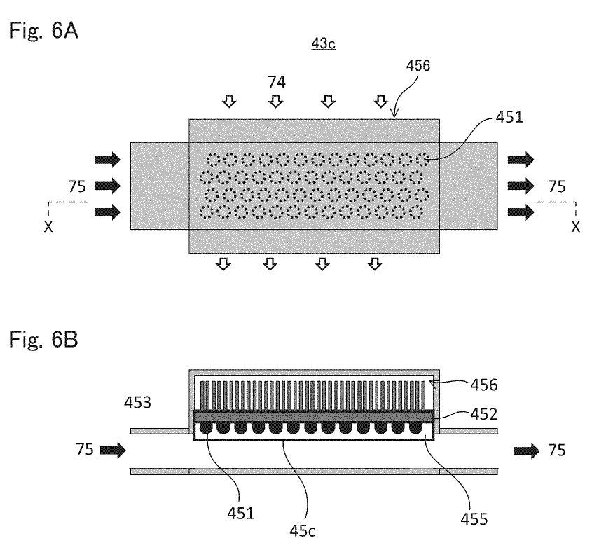

The ultraviolet ray irradiator may directly irradiate an ultraviolet ray (UV) emitted from a light source having the UV-LED to the air to be irradiated, and may include an optical transmission system of including a light guide part and an emission part in addition to the light source, transmitting an ultraviolet ray (UV) emitted from the light source having the UV-LED by the light guide part, and emitting the UV from the emission part. A light source where a plurality of UV-LEDs or UV-LED packages are aligned is preferably used as the light source. Examples thereof include a module light source having UV-LEDs aligned on a metallic heat radiation substrate, and a silica glass package with which the UV-LEDs are covered, ultraviolet rays being emitted from the silica glass package, as shown in FIG. 6 of Patent Literature 10 (JP2015-91582A), and a rod-like module light source that has a cylindrical or polygonal columnar base, and a plurality of UV-LEDs which are disposed on a side surface of the base such that a light axis of each UV-LED passes through the center axis of the base, and emits ultraviolet rays radially to the center axis, as shown in FIGS. 2 and 3 of Patent Literature 9 (JP2014-89898A). Patent Literature 9 also discloses an ultraviolet ray irradiation apparatus that has a light-condensing and collimating device (apparatus main body) including an emission-side reflective mirror composed of a long elliptical reflective mirror, a light-condensation-side reflective mirror composed of a long elliptical reflective mirror, an opening for emitting ultraviolet rays that is provided in the vicinity of a light condensing axis of the emission-side reflective mirror, and a collimating optical system disposed at the opening, wherein on a focal axis of the emission-side reflective mirror of the light-condensing and collimating device, the rod-like module light source is disposed. This ultraviolet ray irradiation apparatus itself can be used as the light source as well.

When the light source itself is the ultraviolet irradiator, and an ultraviolet ray emitted from the light source is directly irradiated to the air to be irradiated, the ultraviolet ray has only to be irradiated to the air while the air is made to flow so that a silica glass package (for a window for light irradiation) of a module light source as disclosed in Patent Literature 10 is in contact with the air. An ultraviolet ray irradiator comprising: an optical transmission system including a light source; at least one emission part selected from a collimator for optical fibers, a lens diffuser plate, a diffusion lens, a light guide plate, etc.; and a light guide part that is composed of at least one optical transmission path selected from an optical fiber, optical waveguide, a light guide plate, etc., and guides an ultraviolet ray emitted from the light source to the emission part, may be used. Examples of the ultraviolet ray irradiator comprising such an optical transmission system include an ultraviolet ray irradiator comprising a surface emitting device (light guide plate) having a light transmissive layer (corresponding to the light guide part), and a light emitting surface (corresponding to the emission part), and a light source as disclosed in Patent Literature 11 (JP2006-237563A). When the light guide plate is used, the light source is usually aligned on the end surface of the light guide plate. Preferably, the ultraviolet ray irradiation apparatus comprising the light-condensing and collimating device, and the above described rod-like module light source disclosed in Patent Literature 9 is used as the light source aligned on the end surface of the light guide plate, thereby UV irradiation can be performed with high intensity.

Ultraviolet ray irradiation may be performed in ducts or pipes where air flows, and may be performed in an ultraviolet sterilization chamber provided with an air flow path. Preferably, inner surfaces of ducts, pipes, the ultraviolet sterilization chamber, etc. where ultraviolet ray irradiation is performed are made by material of large reflectivity against ultraviolet rays in view of improving sterilization efficiency by reflection of an ultraviolet ray. Examples of such material include platinum group metals such as Ru, Rh, Pd, Os, Ir, and Pt; Al, Ag, Ti, alloys including at least one thereof; and magnesium oxide. Among them, Al, platinum group metals, alloys including platinum group metals, or magnesium oxide can be especially preferably employed because having specifically high reflectivity. When the above described inner surfaces are made by the above material, preferably, the surface of the material is further coated with ultraviolet ray transmissive material such as silicon dioxide and fluororesin.

The UV-LED is turned on (operated) by electric power supplied from a power source. Preferably, a battery power source that can be charged and discharged, such as a lithium ion secondary battery is used as the power source. Preferably, the ultraviolet ray irradiator has a light emission control circuit for controlling a forward current of the UV-LED which uses a step-up DC-DC converter or a charge pump.

When ultraviolet ray irradiation is performed, preferably, heat from the UV-LED is radiated using an ultraviolet light emitting diode cooler, to control the UV-LED so that its operating temperature is within a certain range, for suppressing temperature increase of the UV-LED, and achieving stable output and improved durability. The following cooling device can be preferably employed as the above described ultraviolet light emitting diode cooler: a cooling device comprising a heat sink or a radiator, for radiating heat from the UV-LED; and an ultraviolet light emitting diode cooling fluid flow path, and making an ultraviolet light emitting diode cooling fluid directly or indirectly contact with the heat sink or the radiator, to cool the UV-LED. In view of cooling efficiency, as the ultraviolet light emitting diode cooling fluid, one of the following is preferably used: (1) a cooling fluid (specifically, ram air etc.) used in the above described heat exchanger for cooling (for example, heat exchanger for cooling of the ACS); (2) an air cooled by means of the above described cooling turbine (specifically, fresh air for ventilation prepared from the second fresh air); or (3) the first fresh air bled in the step (A). In addition, preferably, the above described (1) or (2) is used when the aircraft is moving (moving on the ground or in flight), and the above described (3) is used when the aircraft is parked.

The ultraviolet light emitting diode cooling fluid flow path is connected with a flow path of the above described cooling fluid used in the heat exchanger for cooling, the bled air conditioning flow path, or a flow path guiding the fresh air for ventilation prepared from the first fresh air to the mixing chamber, for making this (1), (2), or (3) flow in the ultraviolet light emitting diode cooling fluid flow path. More specifically, the ultraviolet light emitting diode cooling fluid flow path is connected with these flow paths via pipes or ducts branching from them, and part of the above (1), (2) or (3) flows into the ultraviolet light emitting diode cooling flow path via a pipe or duct.

The heat sink or radiator is usually integrated with a substrate where the UV-LED is mounted. Heat generated from the UV-LED is emitted to the ultraviolet light emitting diode cooling fluid via the substrate, and the heat sink or radiator. Here, the flow rate of the ultraviolet light emitting diode cooling fluid is adjusted according to the temperature of this cooling fluid while the temperature of the UV-LED is detected by a sensor, thereby the temperature of the UV-LED can be kept at a certain level.

Examples of the light source in which the heat sink or radiator and the UV-LED mounted substrate are integrated include the above described rod-like module light source (grooving when the inner wall surface of a flow path for a cooling medium is subjected to grooving corresponds to a radiative fin) disclosed in Patent Literature 9 (JP2014-89898A), a light source where a thermal transmissive substrate on which a plurality of UV-LEDs (preferably DUV-LEDs) or a plurality of packaged UV-LEDs (preferably DUV-LEDs) are mounted, and a heat sink having a radiative fin or a radiative fin integrated with a heat pipe are connected as described in Patent Literature 10 (JP2015-91582A), Patent Literature 12 (JP2005-354067A), Patent Literature 13 (JP2009-4688A), etc. When the UV-LED is cooled, these radiative fin and ultraviolet light emitting diode cooling fluid may be either directly or indirectly in contact with each other. Examples of indirect contact of the radiative fin and the ultraviolet light emitting diode cooling fluid include the embodiment of using the ultraviolet light emitting diode cooling fluid as a refrigerant cooling means in a vapor cycle cooling system, and making the refrigerant in the vapor cycle cooling system contact with the heat sink or radiator.

In the step (F), the ultraviolet ray may be irradiated to any of the fresh air for ventilation, the air for recirculation, the purified air for recirculation, and the air for ventilation before being supplied to the cabin. In view of high fuel consumption reducing effect and high infectious deceases preventive effect, the ultraviolet ray is preferably irradiated to the air for recirculation or the purified air for recirculation. This is because the first fresh air can be subjected to ultraviolet sterilization outside the aircraft before bled, and sterilization outside the aircraft is preferable in view of reducing fuel consumption of the aircraft, and because the second fresh air has passed through a high temperature environment, and thus there is less necessity to be sterilized again.

In view of sterilization efficiency, ultraviolet ray irradiation is preferably carried out in the pressure space. This is because a sufficient amount of ultraviolet rays can be efficiently irradiated all over an air of a great amount for a short time by carrying out ultraviolet ray irradiation under pressure since the volume of air can be largely decreased by pressurizing the air. Specific pressure “under pressure” is not restricted as far as being higher than the air pressure in the cabin. In view of energy etc. necessary for pressurizing, the pressure is preferably 1.2 times to 5 times, especially 1.5 times to 3 times more than that in the cabin.

Examples of the embodiment of forming the pressure space in the recirculation flow path include the embodiment that the recirculation flow path has the compressor as the air pump, and the release valve or the turbine arranged on the downstream side of the compressor, which are arranged in the flow path. When the turbine is arranged, energy when pressure is released can be recovered and used for generation of electricity for emitting the UV-LED as well. Thus, the turbine is preferably used.

In view of easy maintenance of the ultraviolet ray irradiator, and flexibility in placement and selection of a sterilization part of the irradiator, preferably, the ultraviolet ray irradiator comprises a light source arranged outside the pressure space, which comprises the ultraviolet light emitting diode, and an optical member for ultraviolet ray emission, arranged in the pressure space, to which the ultraviolet ray emitted from the light source is introduced; the ultraviolet ray emitted from the ultraviolet light emitting diode going out from the optical member, in a manner such that the ultraviolet ray is irradiated to the air flowing in the pressure space. The emission part in the above described optical transmission system, specifically the collimator for optical fibers, the lens diffuser plate, the diffusion lens, the light guide plate, etc. can be used as the optical member for ultraviolet ray emission.

Hereinafter the present invention will be more described with reference to the drawings. The present invention is not limited to the embodiments shown in the drawings. In the drawings, some reference sings may be omitted. In a system for air conditioning of an aircraft 10 of the present invention shown in FIG. 1, a first fresh air 71 or a second fresh air 70 is bled into the aircraft from an air bleeding port (not shown) by switch of gate valves 60 and 63. When the first fresh air 71 is bled, the bled first fresh air (that is also a fresh air for ventilation) 71 is introduced into a mixing chamber 50 as it is. When the second fresh air 70 is bled, the bled second fresh air 70 passes through a bled air conditioning flow path 30, to be the fresh air for ventilation, and is introduced into the mixing chamber 50 from an inlet of the fresh air for ventilation 51. In the bled air conditioning flow path 30, the pressure of the second fresh air 70 is regulated by a pressure regulator (not shown), and the second fresh air 70 is cooled by a precooler (not shown). After that, the cooled second fresh air 70 is cooled in a heat exchanger for cooling 31 using a ram air 73 as a cooling fluid, thereafter compressed by a compressor 33, cooled again in a heat exchanger for cooling 32 using the ram air 73 as a cooling fluid, and further subjected to adiabatic expansion in a cooling turbine 34, to be the fresh air for ventilation whose temperature and pressure are adjusted. The structure of the bled air conditioning flow path 30 after cooling in the heat exchanger for cooling 31 is a so-called ACS. This structure may include a reheater, a condenser, and/or a water separator (all of which are not shown). The second fresh air 70 before entering the ACS branches, to be supplied to the mixing chamber 50 as needed by a temperature adjustment valve 61 as an air for temperature adjustment, for heating the air in the mixing chamber. The second fresh air whose temperature and pressure are adjusted by passing through the cooling turbine 34 (that is, fresh air for ventilation 74) branches, to be used as an ultraviolet light emitting diode cooling fluid. The flow rate of the fresh air for ventilation 74 flowing into an ultraviolet light source 45 as the ultraviolet light emitting diode cooling fluid is controlled by a flow rate adjustment valve 62, for controlling the temperature of an UV-LED 451 in the ultraviolet light source 45.

A cabin air 72 is exhausted from a cabin air exhaust port 22 provided for each zone 23 of a cabin 20 by an electric compressor 42 that is an air blowing means, and introduced into the mixing chamber 50 from an inlet of the purified air for recirculation 52 via a recirculation flow path 40 as an air for recirculation. The cabin air 72 is partially exhausted to the outside of the aircraft via a pressure control valve 24 for ventilation. The air for recirculation exhausted from each zone 23 is recovered in the recirculation flow path 40, and passes through a filter apparatus 41 disposed on the upstream of the electric compressor 42, which reduces or removes pollutants, to be a purified air for recirculation. A turbine 44 is disposed on the downstream side of the electric compressor 42. A pressure space is formed between the electric compressor 42 and the turbine 44. The purified air for recirculation whose pressure is raised by the electric compressor 42 is subjected to decompression by the turbine 44, to be fed to the mixing chamber 50. An ultraviolet sterilization chamber 43 is provided in the above described pressure space. An ultraviolet ray emitted from the ultraviolet light source 45 is irradiated to the purified air for recirculation in this chamber, to carry out sterilization.

In the mixing chamber 50, the fresh air for ventilation, the purified air for recirculation that was subjected to ultraviolet sterilization, and if necessary, the second fresh air before entering the ACS are mixed, to prepare the air for ventilation whose temperature and pressure are adjusted to have predetermined values. The obtained air for ventilation is exhausted from an outlet of the air for ventilation 53, branches via ducts, to be supplied into the cabin 20 from a ventilation air supply port 21 that is provided for each zone 23 in the cabin.

A system for air conditioning of an aircraft 10′ of the present invention shown in FIG. 2 is a modified example of the system for air conditioning of an aircraft 10 in FIG. 1 so as to use a fan 46 as an air blowing means in the bled air conditioning flow path 30 instead of the electric compressor 42 and the turbine 44, to perform purification by the filter apparatus 41 and ultraviolet sterilization for each zone of the cabin. The system for air conditioning of an aircraft 10′ has filter apparatuses 41, 41, . . . , and ultraviolet sterilization chambers 43, 43, . . . , respectively corresponding to zones 23, 23, . . . of the cabin. The system 10′ uses the ram air 73 that is a cooling fluid of the heat exchangers for cooling 31 and 32, as the ultraviolet light emitting diode cooling fluid for cooling the UV-LEDs in the ultraviolet light sources 45. The flow rate of the ram air 73 flowing into the ultraviolet light sources 45, 45, . . . as the ultraviolet light emitting diode cooling fluid is controlled by a temperature adjustment valve 64, for controlling the temperature of the UV-LEDs 451 in the ultraviolet light sources 45.

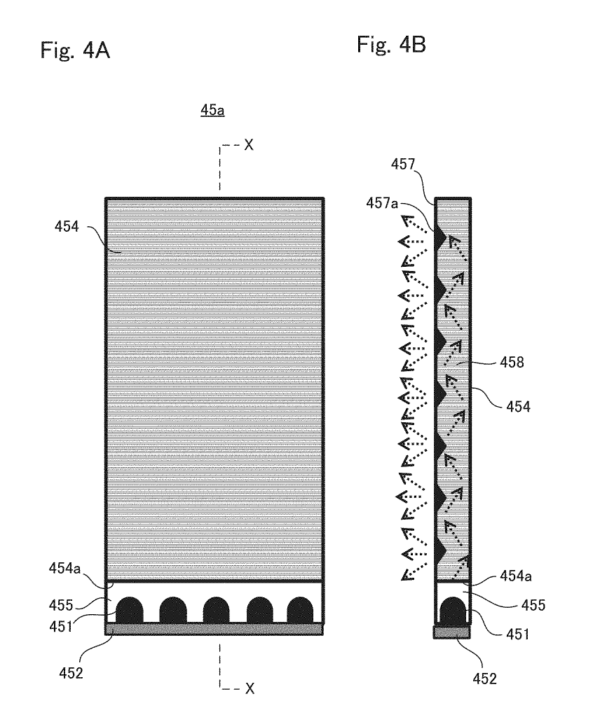

FIGS. 3A to 4B show schematic views of an ultraviolet sterilization chamber 43a and an ultraviolet light source 45a which can be used in the system for air conditioning of an aircraft of the present invention. They can be used either under pressure or under normal pressure (atmospheric pressure or slightly negative pressure). In FIGS. 3A to 4B, a light guide pate 454 is disposed inside the chamber 43a, and the ultraviolet light source 45a having UV-LEDs (preferably DUV-LEDs) 451 is disposed outside the chamber 43a. In the ultraviolet light source 45a, a plurality of the UV-LEDs (DUV-LEDs) 451, 451, . . . , which may be packaged as needed, are aligned in a line and mounted on a substrate 452, and sealed by a cover 455 composed of ultraviolet ray transmissive material (for example, sapphire, and quartz). The substrate 452 is integrated with a heat sink having a radiative fin 453. The radiative fin 453 is exposed to the inside of an ultraviolet light emitting diode cooling fluid flow path 456, and radiates heat generated from the UV-LEDs (DUV-LEDs) 451 to the ultraviolet light emitting diode cooling fluid flowing in the flow path 456 (fresh air for ventilation 74 in FIGS. 3A and 3B). An ultraviolet ray emission surface of the ultraviolet light source 45a is arranged so as to be in close contact with an end surface on the upstream side 454aof the light guide plate 454. For one main surface (light emitting surface) 457 of the light guide plate 454, optical polarizing devices 457a, 457a, . . . are provided, which function as emission parts. Ultraviolet rays emitted from the UV-LEDs (DUV-LEDs) 451 enter the light guide plate 454 from the end surface 454a, are emitted from the light emitting surface 457 via a light transmissive layer of the light guide plate (light guide part 458), and are irradiated to the purified air for recirculation 75 flowing in the chamber 43a.

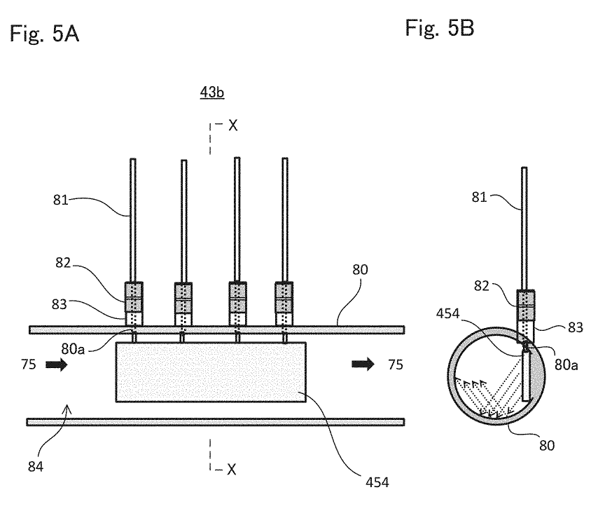

FIGS. 5A and 5B show schematic views of another ultraviolet sterilization chamber 43b that can be used in the system for air conditioning of an aircraft of the present invention. The ultraviolet sterilization chamber 43b is a metallic pipe 80 utilized as a chamber, and the inside thereof is a pressure space 84. Inside the metallic pipe 80, the light guide plate 454 as an ultraviolet ray emission part is disposed. A side face of the light guide plate 454 is optically connected with optical fibers extending from pressure-resistant connectors 83 that are fixed to holes 80a provided for the pipe 80. The optical fibers extending from the pressure-resistant connectors 83 to the outside of the pipe are optically connected with light emission ports of the optical fibers 81 of the light guide parts at couplers 82. Each optical fiber 81 extends to a light entering port (not shown) existing at another end part thereof. Ultraviolet rays emitted from a light source (not shown) are taken in from the light entering ports, are transmitted inside the optical fibers 81, pass through the light emission ports and pressure-resistant connectors 83, and are emitted from the light guide plate 454 as diffused light. The ultraviolet rays emitted from the light guide plate 454 travel while repeatedly reflecting off the inner wall surface of the pipe 80 that is made of ultraviolet ray reflective material, and are irradiated to the purified air for recirculation 75 flowing in the pipe 80, thereby sterilization is performed.

FIGS. 6A and 6B show schematic views of yet another ultraviolet sterilization chamber 43c and ultraviolet light source 45c which can be used in the system for air conditioning of an aircraft of the present invention. The ultraviolet sterilization chamber 43c has the structure of a rectangular (the longitudinal direction is a direction in which the purified air for recirculation flows) flat box-like chamber, wherein ultraviolet rays emitted from the ultraviolet light source 45c are directly irradiated to the purified air for recirculation 75. The ultraviolet light source 45c consists of a rectangular substrate 452 having substantially the same shape as the top surface of the chamber, a plurality of the UV-LEDs (DUV-LEDs) 451 (may be packaged if necessary) aligned and mounted on a surface of the substrate 452 in a plurality of rows and columns, and a cover 455 made of ultraviolet ray transmissive material (for example, sapphire, and quartz), with which the UV-LEDs 451 are sealed. The substrate 452 is integrated with a heat sink having a radiative fin 453. The radiative fin 453 is exposed to the inside of the ultraviolet light emitting diode cooling fluid flow path 456, and radiates heat generated from the UV-LEDs (DUV-LEDs) 451 via the ultraviolet light emitting diode cooling fluid flowing in the flow path 456 (fresh air for ventilation 74 in FIG. 6A). The ultraviolet light source 45c itself is disposed in the ultraviolet sterilization chamber 43c. Thus, the ultraviolet sterilization chamber 43c is preferably used under normal pressure.

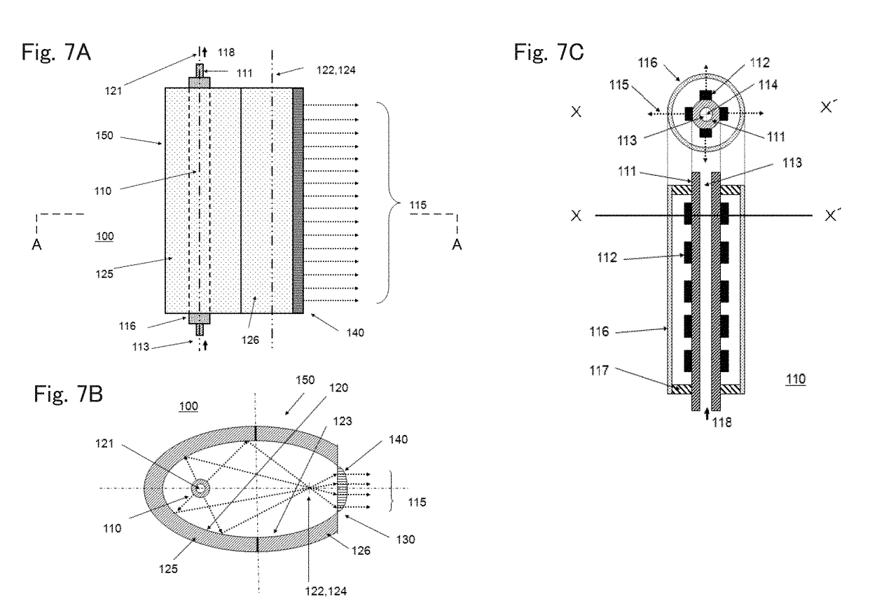

Lastly, FIGS. 7A to 7C show schematic views of still another ultraviolet light source 45d that can be used in the system for air conditioning of an aircraft of the present invention. The ultraviolet light source 45d is the same as the ultraviolet ray irradiation apparatus 100 disclosed in Patent Literature 9 (JP2014-89898A). The ultraviolet light source 45d (ultraviolet ray irradiation apparatus 100) has a main body (light-condensing and collimating device) 150 including a light-emission-side housing 125 having inside an emission-side reflective mirror 120 composed of a long elliptical reflective mirror, a light-condensing-side housing 126 having inside a light-condensing-side reflective mirror 123 composed of a long elliptical reflective mirror, and having an opening for emitting ultraviolet rays 130, and a collimating optical system 140 disposed at the opening for emitting ultraviolet rays 130; and a rod-like ultraviolet light emitting module 110 having a cylindrical base 111, and a plurality of DUV-LEDs 112 arranged on a side surface of the cylindrical base 111, which are disposed such that a light axis 115 of each DUV-LEDs 112 passes through a center axis 114 of the base 111 so that ultraviolet rays are emitted radially to the center axis 114 of the base 112. The ultraviolet light emitting module 110 is disposed on a focal axis 121 of the emission-side reflective mirror, and the opening for emitting ultraviolet rays 130 is disposed in the vicinity of a light condensing axis 122 of the emission-side reflective mirror (that is also a focal axis 124 of the light-condensation-side reflective mirror).

A flow path for a cooling medium 113 is formed inside the cylindrical base 111. The cylindrical base 111 to which the DUV-LEDs 112 are mounted is covered with a cover 116 formed by ultraviolet transmissive material (for example, quartz). The cover 116 is air-tightly or water-tightly mounted to the cylindrical base using a sealing member 117 such as a sealant, packing, and an o-ring. The inside thereof is filled with an inert gas such as nitrogen, or a dry air gas. The cylindrical base 111 functions not only as a support to fix and hold the ultraviolet light-emitting devices 112, but also as a heat sink. That is, by making a cooling medium 118 (for example, the fresh air for ventilation 74, and the ram air 73) flow in the flow path for a cooling medium 113, heat generated from the ultraviolet light-emitting devices is radiated, and temperature increase of the ultraviolet light-emitting devices which is caused by heat can be prevented, so that the devices can be operated stably and device lives can be prolonged.

The above described ultraviolet light source 45d condenses not only light emitted from the DUV-LEDs arranged in the outgoing direction of light, but also light emitted from the DUV-LEDs arranged in directions other than the outgoing direction of light, which makes it possible to emit ultraviolet rays of high intensity as translational light in a band. Therefore, the ultraviolet light source 45d is preferable as a light source used in combination with a light guide plate.

### REFERENCE SIGNS LIST

10, 10′ . . . system for air conditioning of an aircraft
20 . . . cabin
21 . . . ventilation air supply port
22 . . . cabin air exhaust port
23 . . . zone
24 . . . pressure control valve
30 . . . bled air conditioning flow path
31, 32 . . . heat exchanger for cooling
33 . . . compressor
34 . . . cooling turbine
40 . . . recirculation flow path
41 . . . filter apparatus
42 . . . electric compressor
43, 43a, 43b, 43c . . . ultraviolet sterilization chamber
44 . . . turbine
45, 45a, 45c, 45d . . . ultraviolet light source
451 . . . UV-LED (or DUV-LED)
452 . . . substrate
453 . . . radiative fin
454 . . . light guide plate
455 . . . cover made by ultraviolet ray transmissive material
456 . . . ultraviolet light emitting diode cooling fluid flow path
457 . . . emitting part
458 . . . light guide part
46 . . . fan
50 . . . mixing chamber
51 . . . inlet of the fresh air for ventilation
52 . . . inlet of the purified air for recirculation
53 . . . outlet of the air for ventilation
60 . . . gate valve
61 . . . temperature adjustment valve
62 . . . flow rate adjustment valve
63 . . . gate valve
64 . . . temperature adjustment valve
70 . . . second fresh air
71 . . . first fresh air
72 . . . cabin air
73 . . . ram air
74 . . . ultraviolet light emitting diode cooling fluid
75 . . . purified air for recirculation
80 . . . pipe
81 . . . optical fiber
82 . . . coupler
83 . . . pressure-resistant connector
84 . . . pressure space
100 . . . ultraviolet light source
110 . . . ultraviolet light emitting module
111 . . . cylindrical base
112 . . . deep ultraviolet light emitting device (DUV-LED)
113 . . . flow path for a cooling medium
114 . . . center axis of the cylindrical base
115 . . . light axis of the deep ultraviolet light emitting devices
116 . . . cover
117 . . . sealing material
118 . . . cooling medium
120 . . . emission-side reflective mirror composed of a long elliptical reflective mirror
121 . . . focal axis of the emission-side reflective mirror
122 . . . light condensing axis of the emission-side reflective mirror
123 . . . light-condensation-side reflective mirror composed of a long elliptical reflective mirror
124 . . . focal axis of the light-condensation-side reflective mirror
125 . . . light-emission-side housing
126 . . . light-condensation-side housing
130 . . . opening for emitting ultraviolet rays
140 . . . collimating optical system
150 . . . main body

1. A method for air conditioning of an aircraft, the method comprising the steps of:
(A) obtaining a fresh air for ventilation having adjusted pressure and temperature, the step (A) comprising:
bleeding a first fresh air having a first predetermined pressure and a first predetermined temperature; or
bleeding a second fresh air not having a second predetermined pressure and/or not having a second predetermined temperature, and adjusting pressure and temperature of the bled second flesh air to the second predetermined pressure and the second predetermined temperature;
(B) exhausting an air from a cabin to an outside of the cabin;
(C) obtaining a purified air for recirculation, the step (C) comprising:
recovering part of the air exhausted in the step (B) as an air for recirculation; and
removing or reducing a pollutant in the air for recirculation by means of a filter and/or an adsorbent;
(D) mixing the fresh air for ventilation and the purified air for recirculation, to obtain an air for ventilation;
(E) supplying the air for ventilation obtained in the step (D) to the cabin; and
(F) irradiating an ultraviolet ray emitted from an ultraviolet light emitting diode to the fresh air for ventilation, the air for recirculation, the purified air for recirculation, or the air for ventilation before being supplied to the cabin, or combination thereof. thereof,
wherein the step (F) is carried out under a higher air pressure than an air pressure in the cabin.

2. The method according to claim 1,
wherein the step (A) comprises adjusting temperature of the second fresh air by means of a cooling turbine and/or a heat exchanger for cooling;
the step (F) comprises controlling temperature of the ultraviolet light emitting diode by means of:
(1) a cooling fluid used in the heat exchanger for cooling;
(2) an air cooled by means of the cooling turbine; or
(3) the first fresh air bled in the step (A).

3. The method according to claim 1,
wherein the cabin is divided into a plurality of zones; and
the method comprises:
carrying out the step (B), the step (F) wherein the ultraviolet ray is irradiated to the air for recirculation, and the step (E), per each of the plurality of zones; or
carrying out the step (B), the step (C), the step (F) wherein the ultraviolet ray is irradiated to the purified air for recirculation, and the step (E), per each of the plurality of zones.

4. (canceled)

5. A system for air conditioning of an aircraft, the system comprising:
a ventilation air supply port supplying an air for ventilation into a cabin;
a cabin air exhaust port exhausting an air from the cabin;
an air bleeding port bleeding a fresh air, the fresh air not having a predetermined pressure and/or not having a predetermined temperature;
a recirculation flow path comprising: an air pump incorporated in the recirculation flow path; and a filter apparatus incorporated in the recirculation flow path,
the recirculation flow path purifying part of the air exhausted from the cabin air exhaust port by means of the filter apparatus, to prepare a purified air for recirculation;
a bled air conditioning flow path comprising an air conditioning apparatus incorporated in the bled air conditioning flow path, the air conditioning apparatus comprising: a compressor; a cooling turbine; or a heat exchanger for cooling; or combination thereof,
the bled air conditioning flow path adjusting pressure and temperature of the fresh air bled from the air bleeding port, to prepare a fresh air for ventilation;
a mixing chamber comprising:
a first inlet of the purified air for recirculation, the first inlet being connected with the recirculation flow path;
a second inlet of the fresh air for ventilation, the second inlet being connected with the bled air conditioning flow path; and
an outlet of the air for ventilation, the outlet being connected with the ventilation air supply port,
the purified air for recirculation and the fresh air for ventilation being mixed in the mixing chamber, to give the air for ventilation;
an ultraviolet ray irradiator comprising an ultraviolet light emitting diode, the ultraviolet ray irradiator irradiating an ultraviolet ray emitted from the ultraviolet light emitting diode to an air flowing in the recirculation flow path.flow path:,
the recirculation flow path comprising:
a compressor as the air pump;
a release valve or a turbine, arranged on a downstream side of the compressor; and
a pressure space formed between the compressor and the release valve or the turbine; and
the ultraviolet ray emitted from the ultraviolet light emitting diode being irradiated to an air flowing in the pressure space.

6. The system according to claim 5, further comprising:
an ultraviolet light emitting diode cooler comprising:
a heat sink or a radiator, radiating heat from the ultraviolet light emitting diode; and
an ultraviolet light emitting diode cooling fluid flow path, wherein an ultraviolet light emitting diode cooling fluid flows in the ultraviolet light emitting diode cooling fluid flow path;
the ultraviolet light emitting diode cooling fluid flow path being connected with a flow path of a cooling fluid used in the heat exchanger for cooling, or being connected with the bled air conditioning flow path;
the ultraviolet light emitting diode cooling fluid comprising part of the cooling fluid used in the heat exchanger for cooling or part of the fresh air for ventilation; and
the ultraviolet light emitting diode cooler making the ultraviolet light emitting diode cooling fluid directly or indirectly contact with the heat sink or the radiator, to cool the ultraviolet light emitting diode.

7. (canceled)

8. The system according to claim 7claim 5,
the ultraviolet ray irradiator comprising:
a light source arranged outside the pressure space, the light source comprising the ultraviolet light emitting diode; and
an optical member for ultraviolet ray emission, arranged in the pressure space;
the ultraviolet ray emitted from the ultraviolet light emitting diode going out from the optical member, in a manner such that the ultraviolet ray is irradiated to the air flowing in the pressure space.

9. An aircraft comprising:
the system for air conditioning of the aircraft as in claim 5.

10. The method according to claim 2,
wherein the cabin is divided into a plurality of zones; and
the method comprises:
carrying out the step (B), the step (F) wherein the ultraviolet ray is irradiated to the air for recirculation, and the step (E), per each of the plurality of zones; or
carrying out the step (B), the step (C), the step (F) wherein the ultraviolet ray is irradiated to the purified air for recirculation, and the step (E), per each of the plurality of zones.

11. The system according to claim 6,
the ultraviolet ray irradiator comprising:
a light source arranged outside the pressure space, the light source comprising the ultraviolet light emitting diode; and
an optical member for ultraviolet ray emission, arranged in the pressure space;
the ultraviolet ray emitted from the ultraviolet light emitting diode going out from the optical member, in a manner such that the ultraviolet ray is irradiated to the air flowing in the pressure space.

12. An aircraft comprising:
the system for air conditioning of the aircraft as in claim 6.

13. An aircraft comprising:
the system for air conditioning of the aircraft as in claim 8.
